(19) United States
(12) Patent Application Publication
(10) Pub. No.: US 2016/0132120 A1
(43) Pub. Date: May 12, 2016

(54) VENDING MACHINE AND VENDING SYSTEM

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: XIAN-JUN FAN, Wuhan (CN); JIE LI, Wuhan (CN); YE-QUN LIU, Wuhan (CN); YUN-LUNG CHEN, New Taipei (TW)

(21) Appl. No.: 14/557,069

(22) Filed: Dec. 1, 2014

(30) Foreign Application Priority Data
Nov. 12, 2014 (CN) 201410633726.9

(51) Int. Cl. G06F 3/01; G06F 3/03; G09G 5/00; G06Q 30/06

(52) U.S. Cl. CPC G06F 3/017; G06Q 30/0641; G06F 3/0304; G09G 5/003; G09G 2370/02; G09G 2370/16

(57) ABSTRACT

A vending machine includes a camera, a display, and a computer. The computer is coupled to the camera and the display. The computer includes a processor, a storage module and a motion detector. The motion detector can detect a movement of an image captured by the camera. The processor can start to record the image into the storage module when the movement of the image is detected, and can also prompt a message on the display when the movement of the image is detected.

### CROSS-REFERENCE TO RELATED APPLICATIONS

This application claims priority to Chinese Patent Application No. 201410633726.9 filed on Nov. 12, 2014, the contents of which are incorporated by reference herein.

### FIELD

The subject matter herein generally relates to a vending machine and a vending system with the vending machine.

### BACKGROUND

A vending machine is a machine which dispenses items such as snacks, beverages, lottery tickets, consumer products automatically, after the customer inserts currency or credit into the machine.

### BRIEF DESCRIPTION OF THE DRAWINGS

Implementations of the present technology will now be described, by way of example only, with reference to the attached figures.

FIG. 1 is a diagrammatic view of one embodiment of a vending system.

FIG. 2 is a block view of a vending machine of the vending system of FIG. 1.

FIG. 3 is a diagrammatic view of a vending machine of one embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

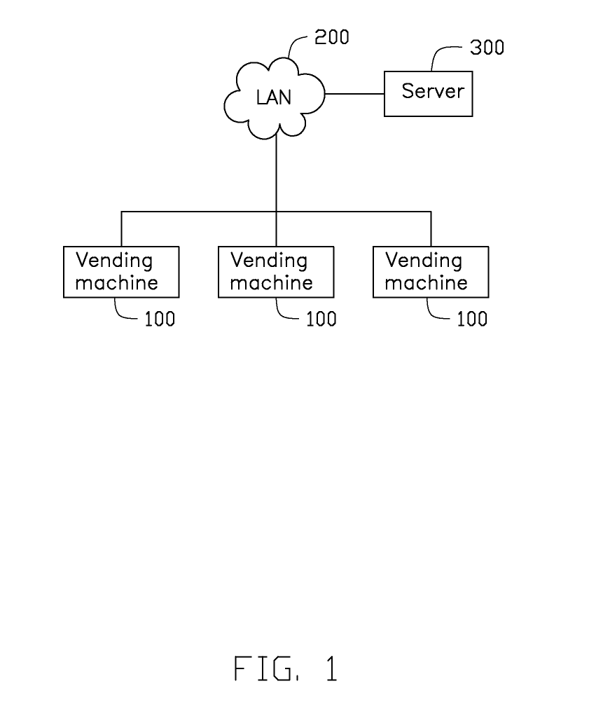

FIG. 1 illustrates a vending system. The vending system can include a plurality of vending machines 100, and a server 300. The plurality of vending machines 100 can be connected to the server 300 through a local area network (LAN) 200. The LAN can be established through wireless network, such as 3G or 4G cellular network.

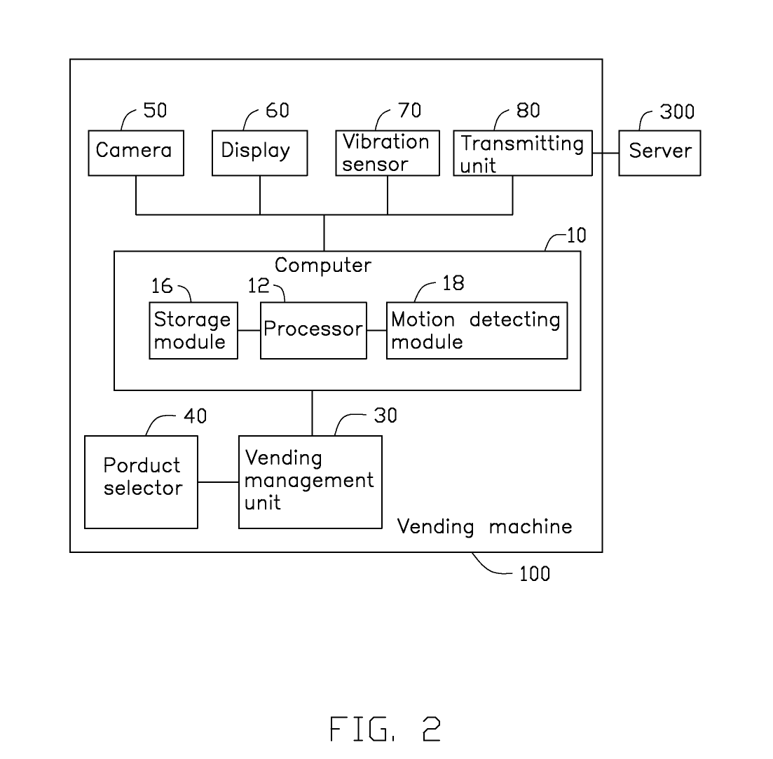

FIG. 2 illustrates a block view of the vending machine 100. The vending machine 100 can include a computer 10, a vending management unit 30, a camera 50, a display 60, a vibration sensor 70, and a transmitting unit 80. The vending management unit 30, the camera 50, the display 60, the vibration sensor 70, and the transmitting unit 80 are coupled to the computer 10. The transmitting unit 80 is connected to the server 300 through LAN.

The computer 10 can include a processor 12, a storage module 16, and a motion detector 18. The storage module 16 and the motion detector 18 are coupled to the processor 12.

The storage module 16 can include high-speed random access memory, and can include non-volatile memory, such as one or more magnetic disk storage devices, optical disk storage devices, flash memory devices, or other non-volatile solid state storage devices. The storage module 16 can optionally include one or more storage devices remotely located from the processor 12. All access to the storage module 16 by other components of the computer 10, such as the processor 12, can be controlled by a memory controller. The processor 12 can run or execute various software programs and/or sets of instructions stored in the storage module 16 to perform various functions for the computer and to process data.

The motion detector 18 can detect a movement of an image captured by the camera 50. One type of motion analysis is to detect image points that refer to moving points in the scene. The typical result of this processing is a binary image where all image points (pixels) that relate to moving points in the scene are set to 1 and all other points are set to 0. This binary image is then further processed, e.g., to remove noise, group neighboring pixels, and label objects. Motion detection can be done using several methods; the two main groups are differential methods and methods based on background segmentation. The motion detector 18 can also carry out human motion analysis, such as human activity recognition, human motion tracking, and analysis of body and body part movement.

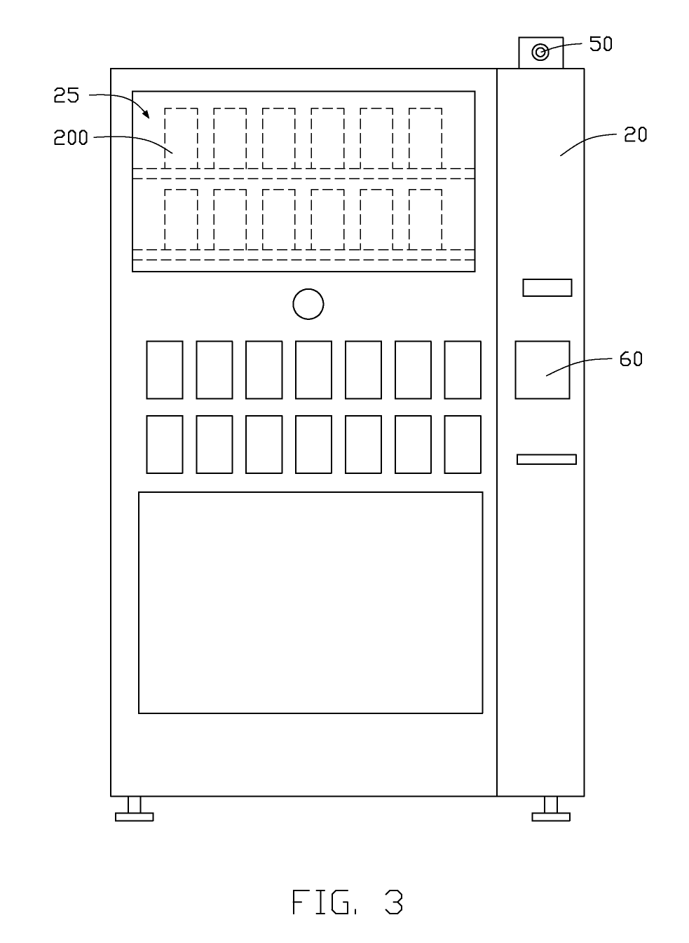

FIG. 3 illustrates a diagrammatic view of a vending machine in one embodiment. The vending machine includes a housing 20. A camera 50 and a display 60 are located on the housing 20. The housing 20 defines a product storage space 25 for receiving a plurality of produces 200 which can be dispensed by a product selector.

The vending management unit 30 can carry out product control or cash management and can control the produce selector to dispense product.

The camera 50 can be control to rotate to capture image around the vending machine 100. The camera 50 can include infrared detecting function.

The display 60 can display product information, stock state, cash information, and warning information, etc. The display 60 can prompt a message when a movement of the image captured by the camera 50 is detected, or a user finish a trade.

The vibration sensor 70 can send warning information to the processor 12 when the vibration sensor 70 detects certain degree vibration. The processor 12 can start to capture the image when receiving the warning information.

The transmitting module 11 can include wireless communication interface and wire communication interface. The wireless communication interface may use any of a plurality of communications standards, protocols and technologies, including but not limited to Global System for Mobile Communications (GSM), Enhanced Data GSM Environment (EDGE), wideband code division multiple access (W-CDMA), code division multiple access (CDMA), time division multiple access (TDMA), BLUETOOTH, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS), or any other suitable communication protocol, including communication protocols not yet developed as of the filing date of this document.

The motion detector 18 can detect a movement of an image captured by the camera 50. The processor 12 can start to record the image into the storage module 16 when the movement of the image is detected, and can stop recording the image when the movement of the image is not detected after a predefined period. The motion detector 18 can activate the camera 50 when movement is detected within a defined area external to a periphery of the housing. The camera 50 is positioned to record images from substantially the defined external area when activated. The motion detector 18 activates the processor 12 to start to store the recorded images in the storage module 16 when movement is detected within the defined area. The motion detector 18 activates the processor 12 to display an image from the storage module 16 on the display when movement is detected within the defined area.

The computer 10 can transmit a real-time image to the server 300 when the computer 10 receives a control command from the server 300.

The embodiments shown and described above are only examples. Many details are often found in the art such as the other features of a method of controlling electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A vending machine, comprising:
a camera;
a display; and
a computer coupling to the camera and the display, the computer comprising a processor, a storage module and a motion detector;
wherein the motion detector is configured to detect a movement of an image captured by the camera; the processor is configured to start to record the image into the storage module when the movement of the image is detected, and is further configured to prompt a message on the display when the movement of the image is detected.

2. The vending machine of claim 1, further comprising a vibration sensor, wherein the vibration sensor is coupled to the computer, the vibration sensor is configured to send a warning information to the processor when the vibration sensor detects certain degree vibration, and the processor is configured to start to capture the image when receiving the warning information.

3. The vending machine of claim 1, further comprising a transmitting unit, wherein the transmitting unit is coupled to the computer, and the image recorded by the storage can be transmitted to a remove server through the transmitting unit.

4. The vending machine of claim 3, wherein the transmitting module is configured to transmit through a wireless network.

5. The vending machine of claim 4, wherein the transmitting module is configured to transmit through a 3G cellular network.

6. The vending machine of claim 1, wherein the computer is configured to transmit a real-time image to a remote server when the computer receives a control command from the remote server.

7. A vending machine, comprising:
a housing;
a product storage space positioned within the housing;
a product selector for selecting dispensing of a product from the product storage space;
a camera;
a display; and
a computer coupling to the camera and the display, the computer comprising a processor, a storage module and a motion detector,
wherein, the motion detector activates the camera when movement is detected within a defined area external to a periphery of the housing, and the camera is positioned to record images from substantially the defined external area when activated;
wherein, the motion detector activates the processor to start to store the recorded images in the storage module when movement is detected within the defined area; and
wherein, the motion detector activates the processor to display an image from the storage module on the display when movement is detected within the defined area.

8. The vending machine of claim 7, further comprising a vibration sensor, wherein the vibration sensor is coupled to the computer, the vibration sensor is configured to send a warning information to the processor when the vibration sensor detects certain degree vibration, and the processor is configured to start to capture the image by the camera when receiving the warning information.

9. The vending machine of claim 7, further comprising a transmitting unit, wherein the transmitting unit is coupled to the computer, and the image recorded by the storage can be transmitted to a remove server through the transmitting unit.

10. The vending machine of claim 9, wherein the transmitting module is configured to transmit through a wireless network.

11. The vending machine of claim 10, wherein the transmitting module is configured to transmit through a 3G cellular network.

12. The vending machine of claim 7, wherein the computer is configured to transmit a real-time image to a remote server when the computer receives a control command from the remote server.

13. The vending machine of claim 7, further comprising a display, wherein the display is coupled to the processor, and the processor is further configured to prompt a message on the display when the movement of the image is detected.

14. A vending system, comprising:
a server; and
a vending machine, comprising:
a camera;
a display; and
a computer coupling to the camera and the display, the computer comprising a processor, a storage module and a motion detector;
wherein the motion detector is configured to detect a movement of an image captured by the camera; the processor is configured to start to record the image into the storage module when the movement of the image is detected, and is further configured to prompt a message on the display when the movement of the image is detected.

15. The vending system of claim 14, further comprising a vibration sensor, wherein the vibration sensor is coupled to the computer, the vibration sensor is configured to send a warning information to the processor when the vibration sensor detects certain degree vibration, and the processor is configured to start to capture the image by the camera when receiving the warning information.

16. The vending system of claim 14, further comprising a transmitting unit, wherein the transmitting unit is coupled to the computer, and the image recorded by the storage can be transmitted to the server through the transmitting unit.

17. The vending system of claim 16, wherein the transmitting module is configured to transmit through a wireless network.

18. The vending system of claim 17, wherein the transmitting module is configured to transmit through a 3G cellular network.

19. The vending system of claim 14, wherein the computer is configured to transmit a real-time image to the server when the computer receives a control command from the server.
